(19) United States
(12) Patent Application Publication
(10) Pub. No.: US 2005/0089813 A1
(43) Pub. Date: Apr. 28, 2005

(54) Matrix wedge restorative dental system and method of use

(76) Inventor: Charles E. Slone, San Juan Capistrano, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/692,574

(22) Filed: Oct. 24, 2003

(51) Int. Cl. A61C 5/04

(52) U.S. Cl. 433/39

(57) ABSTRACT

A matrix wedge restorative system comprising a matrix strip adapted for fitting between a pair of adjacent teeth for supporting a restoration material in one of said pair of teeth; a wedge shaped lingual retainer providing a first gripping means; and a wedge shaped buccal retainer providing a second gripping means; the first and second gripping means enabled for mutual stepwise engagement as the lingual and buccal retainers are drawn together; the lingual and buccal retainers each further providing a V-shaped flexible wedge surface adapted for flexible tight fitting between the pair of adjacent teeth, each of the retainers conformable to surfaces of said teeth. The retainers, together, adapted for pressing the matrix strip into a desired shape and for holding the matrix strip in said desired shape during a tooth restoration.

### BACKGROUND OF THE INVENTION

1. Incorporation by Reference

Applicant(s) hereby incorporate herein by reference, any and all U.S. patents, U.S. patent applications, and other documents and printed matter cited or referred to in this application.

2. Field of the Invention:

This invention relates generally to dental systems for restoring teeth after degradation due to damage or disease and more particularly to such a system using wedge pairs inserted from opposing lingual and buccal sides of the teeth to be restored.

3. Background and Description of Related Art

Dental restorations that involve the outer surfaces of teeth that are adjacent to other teeth are known as class II restorations. The standard technique to restore class II tooth surfaces is to surround the missing tooth structure with a temporary form or matrix. A matrix is usually in the form of a thin flexible metal or plastic strip which is inserted and wrapped around the tooth and held in place by an adjustable metal retaining clamp. Restorative material, usually composite or amalgam, is then flowed or packed into this space confined by the matrix and remaining tooth structure and allowed to harden. The shape of the matrix containing the restorative material thus directly defines the resulting shape of the finished restoration. The final shape of the finished restoration is extremely important to the physiologic health of the tooth and its surrounding hard and soft tissues. If proper contact or contour with the adjacent tooth is not established, food impactions can occur causing periodontal disease or decay. If there is an excess of composite present around the restoration due to a poorly adapted or positioned matrix, excessive finishing time is required by the dentist to properly shape the restoration. It is therefore desirable to have a matrix system that replicates the original contour of the tooth or as closely as possible, or improve on it, and to be able to perform the procedure rapidly and consistently.

Current matrix systems generally comprise three parts: a matrix strip, a matrix strip retainer, and a wedge. The matrix strip with its free ends are connected to the matrix strip retainer is placed around the tooth being restored. The matrix strip retainer is then tightened which takes up any slack in the strip and tightens it against the tooth. This is the well-known Tofflemeyer matrix system. The shape of the tooth however is quite irregular when the relatively flat matrix strip is tightened against a curved tooth structure. Considerable distortion occurs resulting in an excess of restorative material filling in a space where the matrix strip is not properly adapted to the tooth surface. The thickness of the strip creates a very undesirable space or gap between the adjacent tooth when the restorative material is finally hardened and the matrix strip is removed. Therefore an extremely thin strip that is precontoured to the approximate shape of the tooth is desirable. It is difficult to insert extremely thin strips, having a thickness of 25 microns or less, between the teeth without tearing or distorting. The wedge introduced above, is usually a tapered piece of wood or plastic having a triangular cross section and is inserted between the teeth against the matrix strip so as to wedge the matrix strip against the lower margins of the restoration between the two teeth. This results in an improved anatomical shape in the restoration.

There have been improvements on the standard matrix strip and retainer system such as the Palodent System developed by Dr. Alvin Meyer. This system utilizes an open metal ring with bent ends called a “BiTine Ring,” and forms the matrix retainer, serving also as a tooth separator. This system uses a concave shaped sectional matrix along with a conventionally shaped wedge. The technique is to squeeze the embrasure space, that is, the contour of the surfaces between two teeth, and create a separating force between two adjacent teeth. The sectional matrix is used with its spherical shape. Its ends are not attached to a matrix retainer, rather the BiTine Rings has bent ends which pinch the matrix against the tooth wall and separate the tooth at the same time. This system creates a better shaped restoration than the flat matrix strip of the Tofflemeyer system, however it has some shortcomings. First, the sectional matrix is spherical or convex, however the lower margin of the restoration (gingival margin) has a flat or even concave topography. Second, since the sectional matrix has no free ends to attached to a retainer, the matrix cannot be pulled tight or held tight against the tooth. The only tightly held areas of the matrix are the small areas of the split ring's contact. This looseness of the matrix creates excess composite at the margins of the restoration causing additional finishing work. Third, the sectional matrix is also made from stamped metal which tends to crinkle and dent as it is being inserted and placed interproximately. Fourth, the split rings can slip off the tooth at an inappropriate time causing delay, extra work and possibly a ruined restoration. Fifth, this system utilizes metal matrices which, not being transparent, prevent curing light to penetrate into the restoration except from an occlusal access, so that the deeper cervical regions are shielded from the curing light.

Improved matrix strips include those that are molded, pre-contoured plastic strips providing better shape restorations. However, in use, these strips are difficult to keep the contoured portion at the desired location while tightening the strip around the tooth. Also they are usually a compromise shape that is ill-fitted for other than average sized teeth. Also in the areas that the strip does not adapt to the tooth excess composite collects resulting, as previously stated, more work and time in finishing the restoration. A matrix system that is adaptable to most tooth contours and all size teeth, and that is easy to use and also provides an improved experience to the patient is not known at this time. The present invention fulfills these needs and provides further related advantages as described in the following summary.

### SUMMARY OF THE INVENTION

The present invention is a matrix wedge restorative system comprising a matrix strip adapted for fitting between a pair of adjacent teeth for supporting a restoration material in one of said pair of teeth; a wedge shaped lingual retainer providing a first gripping means; and a wedge shaped buccal retainer providing a second gripping means; the first and second gripping means enabled for mutual stepwise engagement as the lingual and buccal retainers are drawn together; the lingual and buccal retainers each further providing a V-shaped flexible wedge surface adapted for flexible tight fitting between the pair of adjacent teeth, each of the retainers conformable to surfaces of said teeth. The retainers, together, adapted for pressing the matrix strip into a desired shape and for holding the matrix strip in said desired shape during a tooth restoration.

The present invention teaches certain benefits in construction and use which give rise to the objectives as follows:

A primary objective of the present invention is to provide an apparatus and method of use of such apparatus that yields advantages not taught by the prior art.

Another objective is to provide such an invention capable of reducing the number of different sizes required in the components that are needed to accommodate the full range of teeth sizes that are present in the population.

A further objective is to provide such an invention capable of reducing or eliminating the finishing time as a result of a tightly fitting anatomically shaped and positioned matrix.

A still further objective is to provide such an invention capable of producing a finished restoration with margins that conform and transition into tooth structure without excess flash.

A still further objective is to provide such an invention capable of inserting the matrix using a technique similar to inserting dental floss and inserting and pulling the wedge retainer strip into place rather than pushing it into place.

A still further objective is to provide such an invention capable of creating an ideally shaped restoration for better periodontal health of the surrounding supporting tissues.

A still further objective is to provide such an invention capable of admitting resin curing light from all angles.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is an elevational view of a matrix strip of the invention showing its position for insertion between teeth;

FIG. 2 is perspective view thereof showing placement of the matrix strip;

FIG. 3 is a perspective view of a finished restoration using the invention;

FIG. 4 is an perspective exploded view of a pair of mating wedge retainers, male and female, of the present invention as viewed from the lingual side;

FIG. 5 is a perspective view thereof, as in FIG. 4 but with the lingual side fully inserted and the buccal side only partially inserted;

FIG. 6 is a perspective view thereof, as in FIG. 5 with the wedge retainers fully engaged;

FIG. 7 is a partial cutaway top plan view thereof showing placement of the wedge retainers relative to the matrix strip;

FIG. 8 is a top plan exploded view thereof showing alignment of the male and female retainers;

FIG. 9 is a top plan view thereof showing male and female retainers fully engaged;

FIG. 10A is an elevational sectional exploded view thereof taken along line 10-10 in FIG. 8;

FIG. 10B is a partial top plan view showing a wing of one of the retainers fully engaged with a tooth;

FIG. 10C is the view of FIG. 10B showing the wing as it approaches the tooth and is not yet engaged therewith, the arrow showing the direction of engagement;

FIG. 11 is an elevational sectional view thereof taken along line 11-11 in FIG. 9;

FIG. 12 is a perspective view of a marginal ridge former of the invention prior to insertion into the restoration area of the teeth;

FIG. 13 is a side elevational view thereof as inserted into the restoration area of the teeth;

FIG. 14 is a side elevational view showing the position of the marginal ridge former as inserted between two lower teeth with a triangular portion jammed by an upper tooth into the marginal ridge;

FIG. 15 is a perspective view of a tension band clamping ring shown as used with the invention; and

FIG. 16 is a top plan view of the embodiment of FIG. 15 but showing the band in an alternate position.

### DETAILED DESCRIPTION OF THE INVENTION

The above described drawing figures illustrate the invention in at least one of its preferred embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

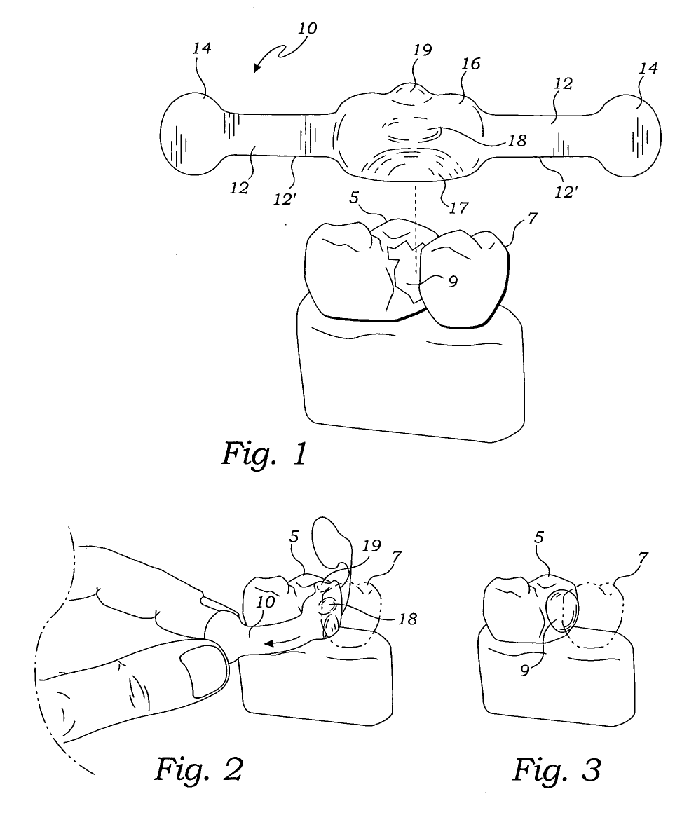

The present invention comprises a matrix system of three component parts: a transparent bi-thickness modified sectional matrix band or strip 10 as shown in FIG. 1, a specially contoured transparent lingual wedge retainer 20 (male part) as shown in FIG. 4 on the left, and a specially contoured transparent buccal wedge retainer 30 also shown in FIG. 4 on the right. The transparent bi-thickness matrix strip 10 is made of a clear flexible plastic material transparent to curing light sources which typically operate at 470 nm, which is a deep blue light.

As shown in FIG. 1, the matrix strip 10 has a pair of symmetrically placed straight portions 12, each having an inserting edge 12′, and an enlarged rounded end 14 one of which is held in the fingers of one hand. The central portion 16 has a larger convex shape meant to be grasped by the fingers of the other hand. The placement of this matrix strip 10 is extremely easy by inserting one of the straight portions 12 in the manner of inserting floss between teeth. Since the matrix strip 10 is not attached to a retainer, a straight portion 12 can be stretched tight and slipped between the interproximal contact of the desired tooth pair 5, 7 in FIG. 1, with a back and forth sawing motion. Once this straight portion 12 has been inserted, the matrix strip 10 is pulled laterally as indicated by the arrow in FIG. 2, and the larger convex portion 16 is thus easily slid into place around the prepared tooth surface without tearing or distorting the matrix strip 10. FIG. 3 shows the finished restoration that is possible using the present system. The shape of the restoration in tooth 5 is true to its original tooth geometry and abuts the adjacent tooth 7. The resilient property of this plastic matrix strip 10 allows it to be pulled into place. The convex portion 16 of the matrix strip has three specially designed areas, as shown in FIG. 1. The bottom area 17 is slightly concave which helps adapt it to the concavity of the gingival margin of the preparation. The middle area 18 is approximately one half the thickness of the surrounding matrix material, i.e., approximately 12 microns thick, and is located where the contact point occurs with the adjacent tooth 7. This middle area is also convex. The reduced thickness in the middle area provides the advantage of creating a tight contact in the finished restoration while being able to be positioned without tearing or distorting the matrix strip's surface. The upper area 19 is also of a reduced thickness, that is, about one-half the surrounding thickness so that it is quite flexible and extends to the upper edge of the matrix strip 10. This flexibility allows the upper area 19 to bend and create a marginal ridge 15 with the help of the other two components of the matrix system, as described below.

Once the matrix strip 10 has been positioned, as shown in FIG. 2, the three areas 17, 18, 19 are positioned at their approximately desired locations relative to the restoration 9 in tooth 5. The lower concave portion 17 is placed against the gingival margin of tooth 5, the convex thinner central portion 18 is positioned where the tooth contact should be; between tooth 5 and tooth 7, and the flexible upper portion 19, where the marginal ridge of tooth 5 should be. It is assumed here, that a portion of the marginal ridge and the tooth contact areas of tooth 5 have been removed in preparing the restoration of tooth 5. The matrix strip 10, at this point, is held loosely against the unrestored tooth surface as shown in FIG. 2.

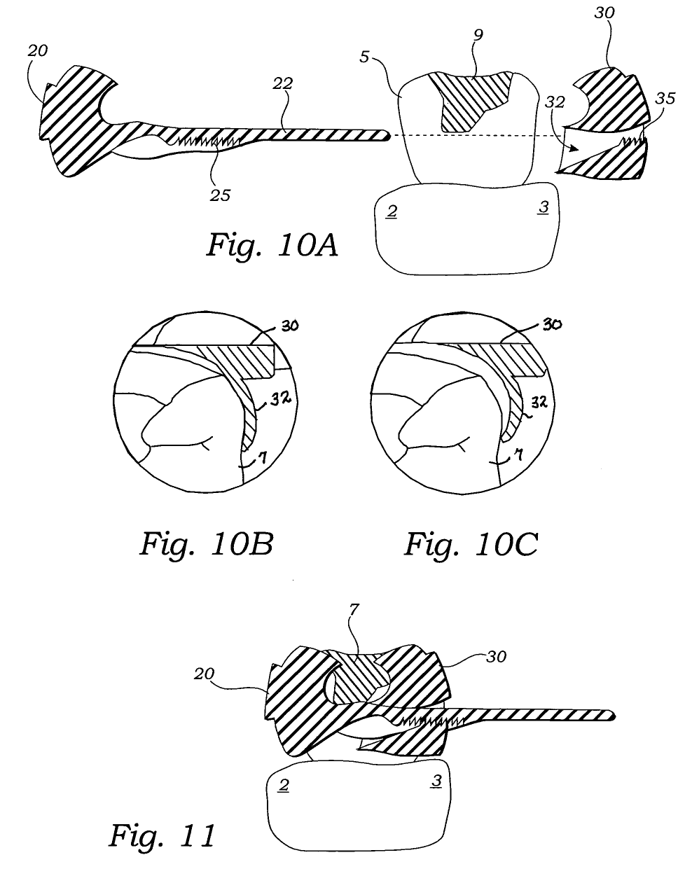

The other two components of the system, carrying out the function of a matrix strip retainer, are now placed. As shown in FIG. 4, the lingual retaining wedge 20 has a long thin tapering, preferably triangular portion 22 at one end that functions as a wedge, and on its other end are two convex wings 23, 24 that are flexible and adapt the matrix strip 10 against the teeth 5 and 7. The wings 23, 24 have a series of radial spaced slits 25 which allows for expansion to accommodate irregularities in tooth shape. The long thin tapering end 22 of the lingual retaining wedge is pressed into the interproximal space 6 between the teeth 5, 7 from the lingual side 2 (FIG. 4). Once it exits on the buccal side 3 of the interproximal space it is grasped and pulled through until the lingual wedge 20 seats itself against the embrasure of the two teeth 5, 7 as shown in FIGS. 10B and 10C. The act of engaging the two retainers may be accomplished by manually pressing them together, or it may be accomplished by the use of a pulling tool of any well known type. When a pulling tool is used, such a tool grips the tapering end 22 of the lingual retainer and presses upon the end surface of the buccal retainer drawing the two retainers toward each other. This is effectively accomplished with the tool placed on the buccal side of the mouth. The aperture 32 of the buccal wedge 30 is pressed onto the long thin tapering portion 22 of the lingual wedge 20 and slid into the interproximal space 6 where it also seats against the tooth embrasure. The buccal wedge 30 also has two concave shaped flexible wings 33, 34. The wings 23, 24, 33, 34 have a radius that is smaller than that of the actual tooth as shown in FIG. 10B so that when pressure is applied by engaging buccal and lingual wedges, the wings flair outward to take the exact shape of the respective teeth (FIG. 10C). The two wedge halves, are then squeezed together as shown in FIG. 11. As the flexible wings 23, 24, 33, 34 come into contact with the curved tooth surfaces the tip edges contact first, and are forced to bend outwardly. As more pressure is applied by squeezing the two wedge halves 20, 30 together a greater portion of the surface of each of the wings 23, 24, 33, 34 comes into contact with the tooth surfaces, further bending and adapting the wings 23, 24, 33, 34 against the matrix strip 10 which sandwiching it between the two halves of the retaining wedges 20, 30 and the tooth 5. Upon further tightening, the matrix strip 10 is precisely adapted to the surfaces and margins of the tooth 5 as shown in FIG. 7. As shown in FIGS. 10A and 11, the two retaining wedges 20, 30 have a retaining mechanism; the lingual side 20 has a row of miniature serrated teeth 25 while the buccal side 30 has a corresponding set of interlocking teeth 35. As the two halves 20, 30 are pressed together they interlock ever more tightly with the teeth 25, 35 preventing disengagement.

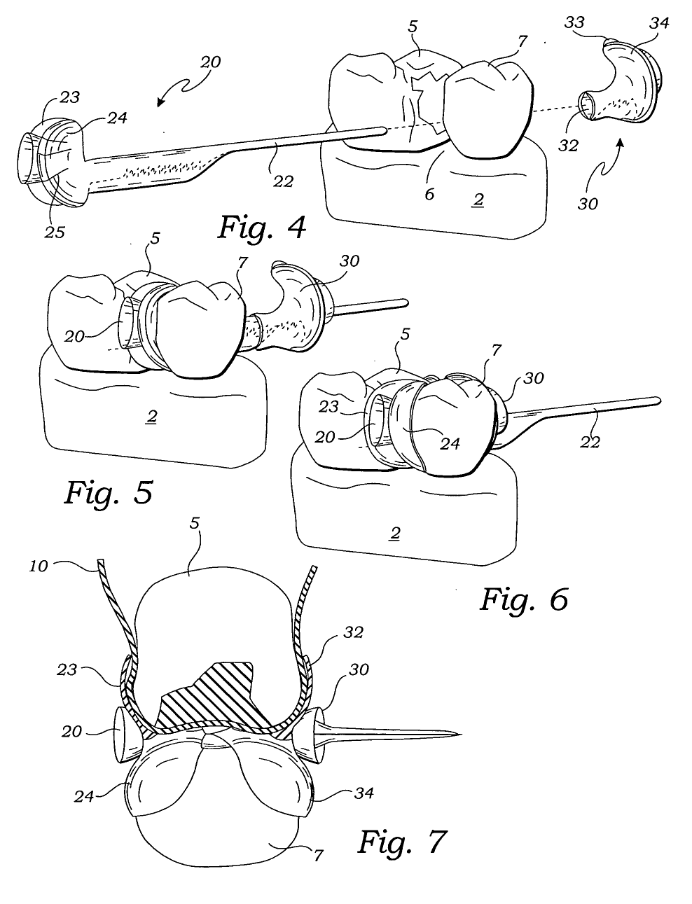

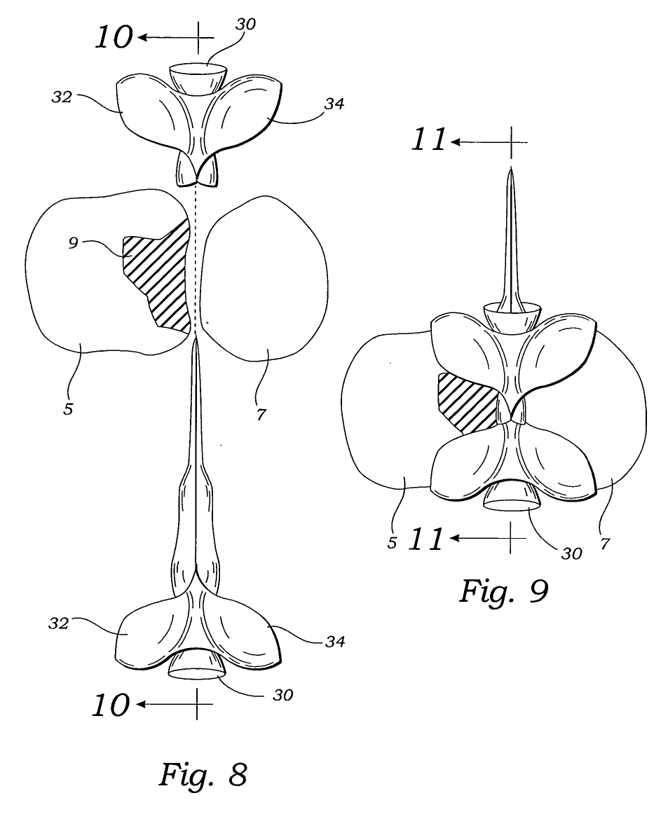

It should be noted that for clarity the matrix strip 10 is not shown in FIGS. 4-6 and 8-11, however, in practice the strip 10 is present. This system is adapted to a proper anatomical shape by the two retaining wedges 20, 30. The triangular wedge portion 22 presses the concave side of the matrix strip 16 against the cervical or lower part of the tooth placing and holding direct pressure to keep the matrix strip 10 adapted to the concave tooth surface in that region. The wing portions 23, 24, 33, 34 of the retaining wedges 20, 30 press and hold the matrix strip 10 tightly against the margins of the prepared tooth so that when restorative material 8 is placed and packed inside the void, its boundaries are even with the rest of the tooth structure. Since the retaining wedge 20, 30 is in two parts and is tightened together against the tooth, it self adjusts to the buccal-lingual distance over a wide range of tooth sizes. Also since the radius of the wing portion is smaller than the tooth curvature it bends and adjusts to varying sizes of tooth embrasure shapes.

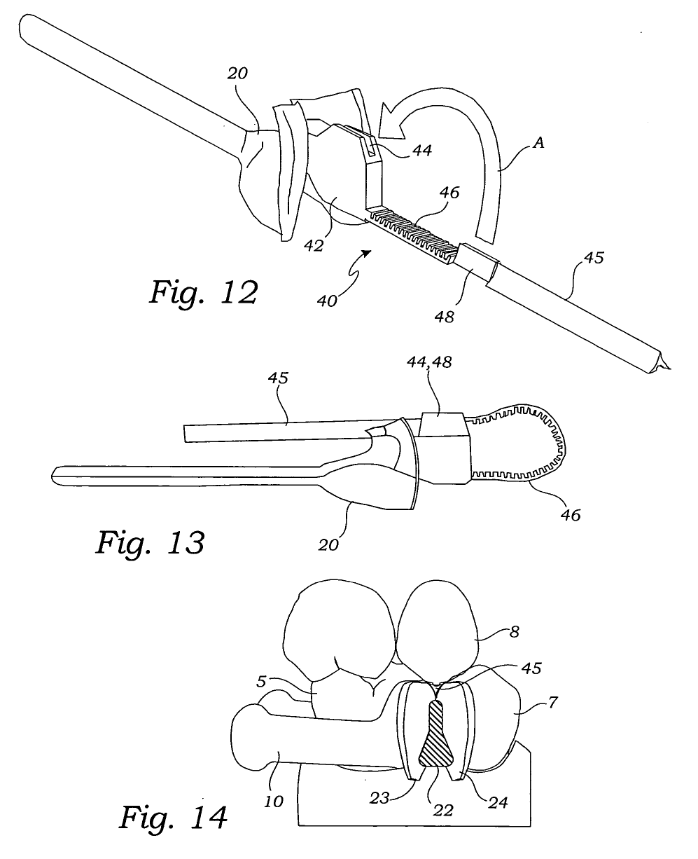

FIG. 12 shows a preferred embodiment of the lingual wedge 20 wherein a marginal ridge former 40 is attached as shown. The marginal ridge former comprises a support member 42 with a support groove 44 mounted on its upper surface. Extending from the support member 42 generally along the axial line of the lingual wedge 20 is, in serial alignment, first, a flexible member 46, next a groove tab 48 and finally a ridge wedge bar 45. This arrangement is clearly shown in FIG. 12. As shown by arrow A, the groove tab 48 is shaped for insertion into support groove 44 and such shape enables a frictional engagement of the groove tab 48 by the support groove 44. FIG. 13 is a side view showing this engagement and the resultant positioning of ridge wedge bar 45. FIG. 14 is an end view with support member 42 cut-away so as to reveal the position of the ridge wedge bar 45 between the marginal ridge of teeth 5 and 7. It is noted that the bar 45 is driven downwardly by upper tooth 8 when the upper and lower teeth are clenched. Bar 45 then is pushed into position to form a replication of the lost marginal ridge surface of tooth 5 prior to curing the restorative.

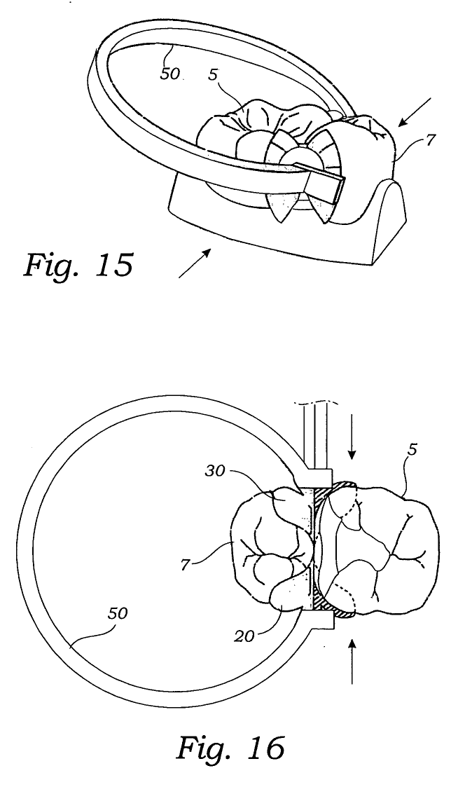

FIGS. 15 and 16 show the use of a clamping ring 50 such as the BiTine Ring described above, in holding the wedges 20, 30 in place. This method may be used in place of the internal teeth 25, 35 of the wedges 20, 30 as described above and illustrated.

The words used in this specification to describe the invention and its various embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of this described invention and its various embodiments are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments below or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

1. A dental matrix wedge restorative apparatus applied to a class II preparation in a position between a tooth for restoring and a further tooth adjacent tooth to the tooth for restoring, the apparatus comprising: a lingual retainer providing a first engagement means; a buccal retainer providing a second engagement means; the first and second engagement means enabled for mutual engagement in drawing the lingual and buccal retainers together within an interproximal space; each of the lingual and buccal retainers providing a resilient and flexible wing extending laterally therefrom and positioned for fully covering a missing tooth sidewall in a class II preparation site on a tooth, for establishing a tooth sidewall boundary when the lingual and buccal retainers are fully engaged.

2. The apparatus of claim 1 further comprising a means for tensioning, the tensioning means positioned for applying engagement pressure to the retainers.

3. The apparatus of claim 2 wherein the tensioning means is a BiTine ring.

4. The apparatus of claim 2 wherein the tensioning means is a series of engaging counterparts within the retainers.

5. The apparatus of claim 1 further comprising a triangular-shaped flexible wedge adapted by size for tight fitting at the marginal ridge between the tooth for restoring and the further tooth adjacent thereto, the flexible wedge of such ductility as to take the shape of the marginal ridge of the tooth for restoring for controlling the shape of the restorative material in the tooth for restoring.

6. The apparatus of claim 1 whereby one of the gripping means comprises a protrusion extending outwardly from one of the retainers, and the other of the gripping means comprises an aperture for accepting insertion of the protrusion.

7. The apparatus of claim 6 whereby one of the gripping means further comprises a series of teeth adapted in shape for insertion of the protrusion into the aperture and further adapted for resistance to withdrawal of the protrusion from the aperture such that the retainers may be drawn together but not apart.

8. The apparatus of claim 1 further comprising a matrix strip providing a marginal ridge area, a contact area and a gingival margin area, the three areas formed contiguously in a generally convex shape adapted by size and conformation for enclosing one side of a tooth surface.

9. The apparatus of claim 8 wherein the marginal ridge area and the contact area of the matrix strip have a lesser thickness than the gingival margin area.

10. The apparatus of claim 9 wherein the retainers, when drawn tightly together against the matrix strip are enabled by size, shape, flexibility, position and placement as to maintain the convex shape of the matrix strip during tooth restoration.

11. A method of establishing a retainer for tooth restoration using a matrix wedge restorative combination, between a tooth for restoring and an adjacent tooth thereto, comprising the steps of: providing a flexible and non-self supporting matrix strip, a lingual retainer and a buccal retainer; adapting the matrix strip for fitting between a pair of adjacent teeth; pressing one of the retainers between the adjacent teeth from a lingual side thereof; pressing the other of the retainers between the adjacent teeth from the buccal side thereof; engaging the two retainers so as to clamp the retainers against the teeth; conforming the shape of the retainers to the shape of the teeth; and conforming the matrix strip to the shape of the teeth by compression of the retainers thereagainst.

12. The method of claim 11 whereby the engaging of the two retainers comprises insertion of a protrusion extending outwardly from one of the retainers, into an aperture of the other of the retainers.

13. The method of claim 12 whereby the insertion of the protrusion includes gripping a series of internal teeth adapted in shape for insertion of the protrusion into the aperture and further adapted for resistance to withdrawal of the protrusion from the aperture such that the retainers may be drawn together but not apart.

14. The method of claim 11 further comprising the step of inserting a triangular-shaped flexible wedge tight fittingly into the marginal ridge between the tooth for restoring and the further tooth adjacent thereto, pressing the flexible wedge into the marginal ridge with an opposing tooth so as to form surface approximating the marginal ridge of the tooth for restoring thereby controlling the shape of a restorative material in the tooth for restoring.
